(19) United States
(12) Patent Application Publication
(10) Pub. No.: US 2022/0177195 A1
(43) Pub. Date: Jun. 9, 2022

(54) Internal imprinting enclosure

(71) Applicant: William C. Brooks, Daytona Beach, FL (US)

(72) Inventor: William C. Brooks, Daytona Beach, FL (US)

(21) Appl. No.: 17/471,321

(22) Filed: Sep. 10, 2021

Related U.S. Application Data
(60) Provisional application No. 63/122,422, filed on Dec. 7, 2020.

(51) Int. Cl. B65D 27/00; B65D 27/14; B65D 27/28; B41M 5/03

(52) U.S. Cl. CPC B65D 27/005; B41M 5/03; B65D 27/28; B65D 27/14

(57) ABSTRACT

An assembly for imprinting markings onto articles that are contained within enclosures includes a pocket-type enclosure and a pressure-sensitive transfer sheet positioned within the enclosure so that when stamping pressure is applied to the outside of the enclosure, an impression is transferred from the transfer sheet to another article that disposed within the enclosure.

This non-provisional application claims the benefit of provisional application No. 63/122,422 filed Dec. 7, 2020.

### BACKGROUND

The present invention generally relates to marking articles contained within closed enclosures, and it is specifically directed to a method and system for applying a timestamp or other type of identifying marking onto a voting ballot at some time after it is deposited and sealed within a mailing envelope.

As was most vividly revealed in the 2020 U.S. presidential election, questions concerning precisely when a voting ballot, that is cast by mail, was deposited with the U.S. Postal Service (“USPS”) or, subsequently, arrived at a vote processing facility are ripe for controversy and, depending on a state's voting laws, the correct answer to either of those questions can determine whether a ballot has been legally cast and, therefore, its votes should be counted. So, voting by mail (including what may be referred to as “absentee voting”) presents a potential chronology-related problem that is yet to be resolved to the satisfaction of many Americans. To understand this challenge, the vote-by-mail process should be understood.

Typically, a voter who intends to vote-by-mail is provided a voting ballot and a return envelope for mailing the completed ballot to a processing center (and, sometimes, a third article which is another envelope or security sleeve inside which the ballot is to be directly placed prior to their being deposited into the mailing envelope). After marking the ballot to register voting choices, a voter is to place the completed ballot into the mailing envelope, seal the envelope, and deposit it with the USPS for delivery to a ballot processing center address written on the envelope. Upon taking custody of that mailing envelope, the USPS will stamp a postmark on the outside of the envelope and deliver it to processing facility address.

When that ballot-containing and postmarked mailed envelope reaches the processing facility—at least in jurisdictions where the ballot arrival date (as opposed to the mail postmark date)—is consequential in determining whether the ballot has been timely cast, an important step in the ballot processing exercise is for the election officials to timestamp the [outer] mailing envelope to indicate its date of arrival to the processing facility. This is intended to ensure that later arriving ballots can be retained for some time, but properly segregated from timely arriving ballots.

The problem lies, however, in the reality that the only recorded proof of the ballot's date of arrival at the vote collecting facility is the timestamp appearing on the outside of the envelope that the ballot was mailed in—an envelope that the ballot will eventually be removed from and could wind up being discarded or separated from the ballot in such a way that the notation regarding a ballot's arrival date (i.e., the postmark) is forever separated from that ballot. Consequently, the fact of the timestamp not being on the voting ballot, itself, can be highly problematic in elections where various aspects of ballot handling by election officials is called into question. This is particularly true concerning the issue of when ballots were received by the ballot processing facility in jurisdictions where that question bears on the issue of ballot validity.

Consequently, the present inventor recognizes a need to be able to directly mark a voting ballot with a timestamp while that ballot is inside of a mailing envelope and without the need to open the envelope to do so. Furthermore, he also recognizes that that same need to stamp a marking onto a document that is enclosed within a sealed pocket enclosure is felt in other contexts not related to voting and not limited to ballots or even mailing envelopes. The present internal imprinting enclosure and method for its use fulfills this outstanding need.

### SUMMARY

It is an object of the present invention to provide a system for directly applying markings, be they timestamps or other indicia, to voting ballots or other articles while they are contained within mailing envelopes or similar enclosures.

In one aspect of the present internal imprinting system, the system is formed by an [outer] enclosure and a transfer sheet that is situated within the enclosure and is for stamping a marking(s) onto an article to be contained within the enclosure.

In another aspect of the invention, the enclosure can be a mailing envelope that is to be deposited with the USPS or other package delivery service, or it could be some other type of sealable enclosure. The transfer sheet can be a pressure-sensitive sheet of material, such as carbon paper or graphite paper, that is useful for imprinting an ink, coating, or other marking substance onto a substrate upon it being pressed against the substrate. The “article” can be a voting ballot or a wide range of other things within the scope and spirit of the invention.

It is another object of the invention to provide an additional layer of retainable tracking information about a mail-in voting ballot to better instill confidence in the election process. By enabling completed ballots to be timestamped (typically, at the election facility to which they were mailed by voters) after they are already sealed within mailing envelopes, the method of the present invention permits those ballots to be removed and separated from their postmarked envelopes without any fear of losing track of when the ballots arrived at the facility. Heretofore, in voting jurisdictions where the voting deadline is a specific date by which a remotely completed ballot are required to arrive at designated vote processing facility, it may have been incumbent upon elections officials to either (a) immediately remove every received ballot from its postmarked mailing envelope and timestamp the ballot itself; or (b) immediately timestamp the outside of each received envelope and, thereafter, make absolute certain that each such timestamped envelope is never separated from it ballot contents which have no corresponding dates of receipt marked on them.

### BRIEF DESCRIPTION OF THE DRAWINGS

FIG. 1 is a rear elevational view of an envelope component of the internal imprinting enclosure of the present invention, the envelope being shown in an unassembled state;

FIG. 2 is a perspective view of a transfer sheet component of the present invention.

FIG. 3 is a rear elevational view of the transfer sheet attached to a panel of the envelope;

FIG. 4 is a rear perspective view of the internal imprinting enclosure, the envelope component being shown in an assembled, open state;

FIG. 5 is a schematic view of an article being placed within the internal imprinting enclosure; and

FIG. 6 is a schematic view of an article being removed from the internal imprinting enclosure.

### DETAILED DESCRIPTION OF THE PREFERRED EMBODIMENTS

This disclosure, as defined by the claims that follow, broadly relates to an assembly for stamping markings onto articles that are contained within pocket-type enclosures. A preferred embodiment of one such assembly that is useful for directly timestamping mailed-in voting ballots while they are still inside their respective mailing envelopes is described in the discussion that follows.

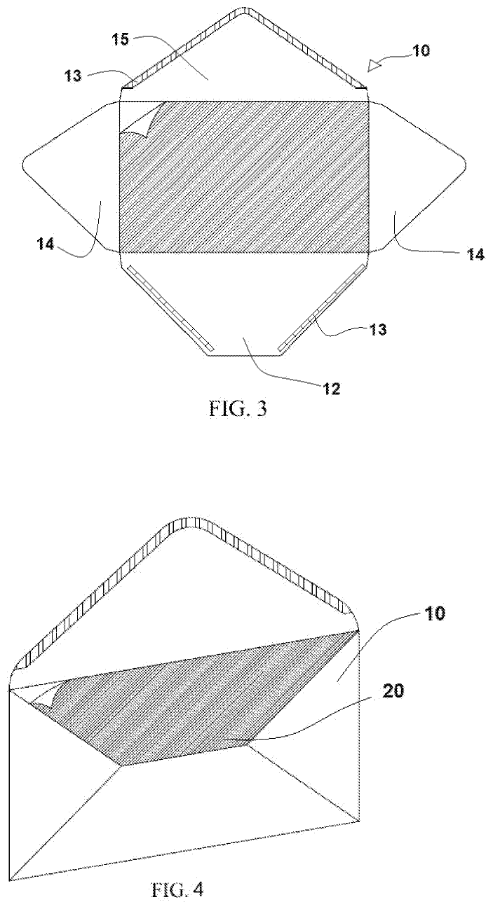

As can be gleaned from viewing FIGS. 1-4, the internal imprinting enclosure of the present invention is formed by a pocket enclosure 10 and a pressure-sensitive transfer sheet 20. In this preferred embodiment, the enclosure 10 is a mailing envelope, but in other embodiments, it may be another type of enclosure that has an open pocket and a mechanism for closing the pocket.

Nevertheless, as shown in FIG. 1, in an unassembled state, the envelope 10 is a single sheet of paper that has multiple creases which form a front panel 11, a back panel 12, an opposing pair of side panels 14, and a flap 15. To transform the envelope from its unassembled, planar sheet state, shown in FIG. 1, to its assembled state, shown in FIG. 4, the side panels are folded laterally inward, the back panel 12 is folded longitudinally upward, and the back panel 12 is permanently secured to the side panels, by way of adhesive 17 along the edges of the back panel 12, forming an open pocket enclosure. The flap 15 folds laterally downward and has an activatable adhesive strip 13, along its inner edges, which allows the flap 15 to be [semi-]permanently secured to the back panel 12 to close the pocket.

Although depicted as a letter envelope in this preferred embodiment, within the scope of the invention, the enclosure 10 can be other types of pocket enclosures, and the pocket-closing mechanism employed can be altogether different from the adhesive-type mechanism of the illustrated embodiment. For example, it could be defined by any number of different fasteners.

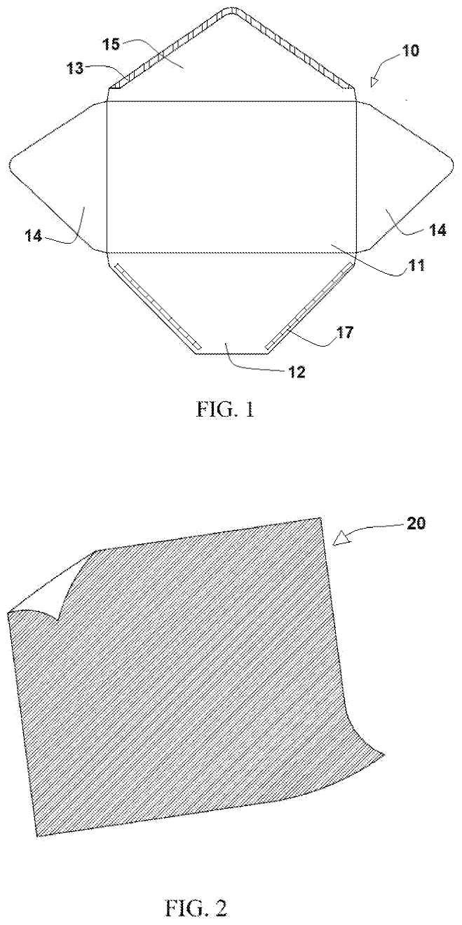

In a preferred embodiment, the transfer sheet 20 is a one-sided, adhesive-backed sheet of carbon paper (See FIG. 2), but it could be graphite paper or any suitable pressure-sensitive sheet material capable of transferring an ink, coating, or other marking substance onto a substrate upon stamping pressure being applied to the sheet 20.

As gleaned from FIGS. 1, 3, and 4, the transfer sheet 20 is adhesively affixed to the envelope back panel 11 and, thereby, permanently secured to the inner wall of the envelope 10 in this embodiment. However, in other embodiments, the transfer sheet 20 can be unattached to the enclosure and simply rest inside of it. In any case, the transfer sheet 20 is to fit inside the enclosure 10 so that it will be adjacent another article that also fits inside the enclosure 10 and is to be pressure imprinted.

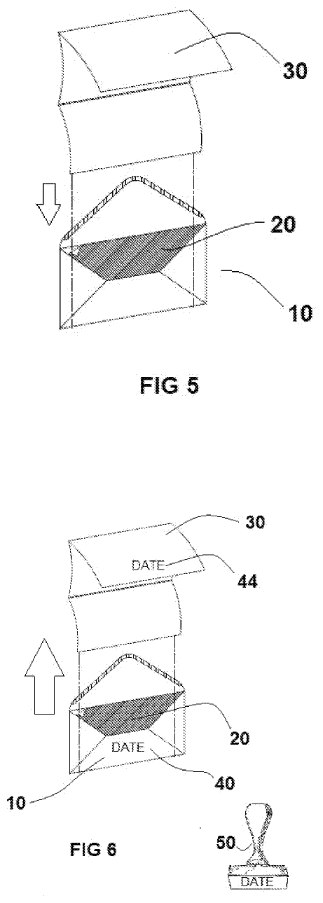

As shown in FIG. 5, a voting ballot 30 or another article of sheet material is to be inserted downward into the open envelope 10. Subsequently, the envelope 10 is to be closed (at least substantially)—trapping the ballot 30 against the transfer sheet 20 inside the envelope 10. Then, as indicated in FIG. 6, when a stamping tool 50 is pressed against a desired stamping location 40 along the closed envelope 10, that stamping pressure will cause a marking 44 to be imprinted on the ballot 30 enclosed within the envelope 10. Preferably, the composite stamping surface of the stamping tool 50 forms a timestamp or other indicia. However, the stamping tool 50 could have a planar stamping surface and the transfer sheet could have its exposed marking substance (e.g., ink) configured to impress the desired marking design on the adjacent ballot 30. In any case, the timestamp 44 or other indicia pressure imprinted on the voting ballot 30 is revealed upon the ballot 30 being lifted out of the re-opened envelope 10.

What is claimed is:

1. An internal imprinting enclosure comprising:
a pocket;
a closing mechanism for closing the pocket; and
a pressure-sensitive transfer sheet disposed within the pocket, the transfer sheet for imprinting a marking(s) onto an article that is also disposed within the pocket upon pressure being applied to the pocket.

2. The internal imprinting enclosure of claim 1, wherein said closing mechanism comprises a flap extension of said pocket, and wherein the flap extension is securable over the opening of said pocket.

3. The internal imprinting enclosure of claim 1, wherein said closing mechanism comprises a fastener(s).

4. The internal imprinting enclosure of claim 1, wherein said closing mechanism comprises adhesive material disposed near the opening of said pocket.

5. The internal imprinting enclosure of claim 1, wherein said transfer sheet comprises carbon paper.

6. The internal imprinting enclosure of claim 1, wherein said transfer sheet comprises graphite paper.

7. The internal imprinting enclosure of claim 1, wherein said transfer sheet is attached to said pocket.

8. The internal imprinting enclosure of claim 1, wherein said transfer sheet is configured to imprint a timestamp or indicia.

9. The internal imprinting enclosure of claim 1, wherein said pocket is an envelope.

10. The internal imprinting enclosure of claim 1, further comprising a stamping element for applying pressure to said transfer sheet and imprinting a marking(s) onto an article that is disposed within said pocket.

11. An internal imprinting enclosure system comprising:
an outer enclosure having a closing mechanism;
an article that is disposable within the outer enclosure;
a pressure-sensitive transfer sheet that is disposable within the outer enclosure, the transfer sheet for imprinting a marking(s) onto the article upon the article and transfer sheet being disposed within the outer enclosure and pressure being applied to the outer enclosure.

12. The internal imprinting enclosure system of claim 11, further comprising a stamping element for applying pressure to said transfer sheet and imprinting a marking(s) onto said article when said article and said transfer sheet are disposed within said pocket.

13. The internal imprinting enclosure system of claim 11, wherein said transfer sheet comprises carbon paper.

14. The internal imprinting enclosure system of claim 11, wherein said transfer sheet comprises graphite paper.

15. The internal imprinting enclosure system of claim 11, wherein said transfer sheet attached to said outer enclosure.

16. The internal imprinting enclosure system of claim 11, wherein said outer enclosure is an envelope.

17. The internal imprinting enclosure system of claim 11, wherein said article is an envelope.

18. A method of imprinting a timestamp or indicia onto an article that is enclosed within an envelope, the method comprising:
disposing an article within an open envelope;
substantially closing the envelope with the article disposed therewithin; and
imprinting a timestamp or indicia onto the article while it is disposed within the substantially closed envelope.

19. The method of claim 18, wherein a pressure-sensitive transfer sheet is also disposed within the substantially closed envelope, and further comprising the step of pressing a stamping element against the substantially closed envelope so as to imprint a timestamp or indicia onto the article disposed therewithin.

20. The method of claim 19, wherein the transfer sheet is configured to imprint a timestamp or indicia.
